(19) United States
(12) Patent Application Publication
(10) Pub. No.: US 2012/0200711 A1
(43) Pub. Date: Aug. 9, 2012

(54) SYSTEM AND METHOD FOR INTEGRATED SURVEILLANCE AND EVENT NOTIFICATION

(75) Inventor: Lawrence T. Dolin, Sands Point, NY (US)

(73) Assignee: AMERICAN REMOTE VIDEO, INC., Long Island City, NY (US)

(21) Appl. No.: 13/204,142

(22) Filed: Aug. 5, 2011

Related U.S. Application Data
(60) Provisional application No. 61/439,002, filed on Feb. 3, 2011.

(51) Int. Cl. H04N 7/18

(52) U.S. Cl. 348/159; 348/E07.085

(57) ABSTRACT

In an embodiment, a system and method are provided for storing at least one database that includes electronic surveillance information of video content and audio content from video surveillance equipment located at a plurality of multi-dwelling units, meta-data associated with the electronic video content and user information associated with a plurality of registered users. First electronic surveillance information is received that includes one or more of video content and audio content respectively associated with a first multi-dwelling unit, and first electronic meta-data representing information associated with the first electronic surveillance information. The processor(s) determine at least one event, and transmit to a first user computing device electronic event information associated with the event and at least some of the first electronic surveillance information. The processor(s) receive from the first user computing device at least a first electronic command representing an action to be taken at the first multi-dwelling unit, and transmit the first electronic command to an access control computing device. The processor(s) receive electronic message information representing a message for at least one of the plurality of users; and transmit the electronic message information to a message computing device.

### CROSS RELATED APPLICATION

This application is based on and claims priority to U.S. Provisional Patent Application Ser. No. 61/439,002, filed on Feb. 3, 2011 and entitled “SAFE LOBBY,” the entire contents of which are hereby incorporated by reference.

### BACKGROUND

1. Field

The present application relates generally to security and, more particularly, to remote security and surveillance for a plurality of buildings over a communication network.

2. Description of the Related Art

Many buildings are equipped with doormen who provide various services for occupants and residents. For example, doormen interact with various commercial providers, such as to accept packages, provide entry for service personnel and relay messages for various people. Doormen also provide security services. It is recognized by the inventor that forced entries, violent crimes and various criminal activity, including those that are associated with loitering, are often prevented or stopped by doormen. Many residents in cities throughout the world consider doormen to be an essential prerequisite before electing to purchase or rent apartments, office space or other building space.

### SUMMARY

A system and method are provided herein for a complex and integrated arrangement of equipment for surveillance, communications, monitoring and control for doors, windows or other entranceways, as well as public and private space within a building.

In an embodiment, a system and method are provided for storing on one or more processor readable media that are operatively coupled to one or more processors, at least one database. The database(s) include electronic surveillance information comprising one or more of video content and audio content respectively obtain from video surveillance equipment located at a plurality of multi-dwelling units, electronic meta-data associated with the electronic video content and the electronic audio content and user information associated with a plurality of registered users. First electronic surveillance information is received from a first DVR/NVR computing device that includes one or more of video content and audio content respectively associated with a first of the plurality of multi-dwelling units, and first electronic meta-data representing information associated with the first electronic surveillance information. The processor(s) determine at least one event, and transmit to a first user computing device electronic event information associated with the event and at least some of the first electronic surveillance information. The processor(s) receive from the first user computing device at least a first electronic command representing an action to be taken at the first multi-dwelling unit, and transmit the first electronic command to an access control computing device. The processor(s) receive electronic message information representing a message for at least one of the plurality of users; and transmit the electronic message information to a message computing device.

Other features and advantages of the present application will become apparent from the following description of the invention that refers to the accompanying drawings.

### BRIEF DESCRIPTION OF THE DRAWINGS

For the purpose of illustrating the invention, there is shown in the drawings several forms, which are presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement in accordance with an embodiment of the present application;

FIG. 2 illustrates functional elements, of which one or more may be configured in an computing device in accordance with an embodiment;

FIG. 3A illustrates an example building arrangement in accordance with an embodiment of the present application;

FIG. 3B illustrates an example hardware arrangement, including computing devise that are accessible by or provided with a central station;

FIG. 3C illustrates an example hardware arrangement, particularly associated with a central station in accordance with an embodiment of the present application;

FIG. 3D is a flow chart illustrating steps associated with transmitting information to and from respective devices;

FIG. 4 illustrates an example building that is configured with hardware and software providing functionality in accordance with an embodiment;

FIG. 5 illustrates interior space of an example building configured in accordance with an embodiment of the present application;

FIG. 6 illustrates an example lobby area in a building configured in accordance with the teachings herein, and represents anti-loitering functionality;

FIG. 7 illustrates functionality associated with ensuring that doors and other entryways in a building are securely closed;

FIG. 8 is a flowchart that illustrates example steps associated with a child arriving at home and parents being notified that the child is safe; and

FIG. 9 is a flowchart illustrating example steps associated with anti-loitering measures provided in accordance with the present application.

### DESCRIPTION OF EMBODIMENTS

The present application provides systems and methods that include complex and integrated arrangements of equipment for surveillance, communications, monitoring and access control, for example, of locks for doors, windows or other entranceways. Preferably, data are generated by devices associated with the equipment, and transmitted to one or more computing devices at a central monitoring station. The data may be provided to one or more computing devices that are operated by personnel, which may be communicatively coupled to each of a plurality of security systems that are installed in a plurality of locations.

In an embodiment, security systems are installed in multi-dwelling units, such as apartments, co-ops and condominiums. In an embodiment, a plurality of multi-dwelling units are configured with security systems that communicate with the central station that is located offsite and accessible over a communication network. Data that are acquired by surveillance systems are preferably provided, for example, in a digital video recording unit (DVR) and may be used to generate and/or transmit information to the central station. Information or data that that are received by the central station may include, for example, video and audio data, as well as textual (e.g., meta data) and/or message data, such as to represent at least some of the video/audio content. Moreover, information and/or one or more various conditions. At least some of the information received at the central station is preferably stored.

In an embodiment, speakers and microphones are installed in various locations within multi-dwelling units, which enable individuals to communicate with the central station. The central station also is configured to communicate with law enforcement or emergency medical personnel, as well as to communicate with one or more designated individuals associated with a respective building or a multi-dwelling unit.

Thus, a plurality of devices, including remote security and surveillance equipment and computing devices, operate to send and receive information regarding multi-dwelling units or businesses to the central station. Preferably, the various equipment operate in an uninterrupted fashion, and are configured to periodically transmit an indication that one or more components are functioning currently and within operational specifications. Accordingly, a form of confirming “heartbeat” is transmitted, and heartbeat-related data may be stored for future reference.

In accordance with the teachings herein, access to buildings is restricted to authorized personnel (such as tenants, residents or employees) and various operations, such as ensuring that doors are closed, detecting forced entry, communicating with occupants as occupants enter and exit a building, and prohibiting loitering in or around a lobby of a building, are also provided. Moreover, information associated therewith is generated by one or more respective devices and the information is transmitted for eventual use at the central station. For example, a sensor at a multi-dwelling building may determine that a front door is ajar, which causes a client device at the building to transmit a message to a server computer at the central station. The server computer uses the information received from the device to communicate with a responsible party to investigate and correct the problem.

The present application also supports communicating with individuals, such as when they enter and exit buildings, as well as with individuals who may be off-site, such as residents who are at work. Information relating to comings and goings in a building may be generated and provided to the central station and used for generating and sending messages to one or more individuals when a particular person or a group of people arrive or leave a building. For example, a parent is notified by e-mail or short message service (“SMS”) when his or her child arrives home safely from school. An information processor, such as a server computer, located at the building identifies the child and a message is automatically transmitted to the parent notifying him or her that the child has arrived. In an embodiment, the parent can access a secure web site and view video content of her child arriving home. Referred to herein, generally as latch-key child notification, parents can use the present application to be confident that their child is safe and accounted for.

Other communications for parties associated with a multi-dwelling unit are provided. One party may receive a notification of one particular event, while a different party may be notified of a different event. For example, when a door of a building is ajar and not closed properly, an SMS, email message and/or other form of message, such as an audible message, is transmitted to the owner of the building or a manager of the building so that corrective action can be taken right away to secure the door. In a different context, such as a forced entry, one or more messages may be sent to emergency personnel, such as police, fire personnel or emergency medical services personnel for immediate dispatch, as well as to the owner or manager. Thus, the teachings herein provide for contextual notification services.

Further, access control and closed circuit television surveillance is provided around the clock, twenty-four hours a day, seven days a week to ensure a safe lobby and entrance area. Loitering and various forms of unauthorized solicitation are prevented. Moreover, a video “escort” service is provided to greet residents as they enter and leave residential and other buildings, and may include tracking functionality, as well, to provide archived records of goings on in a building.

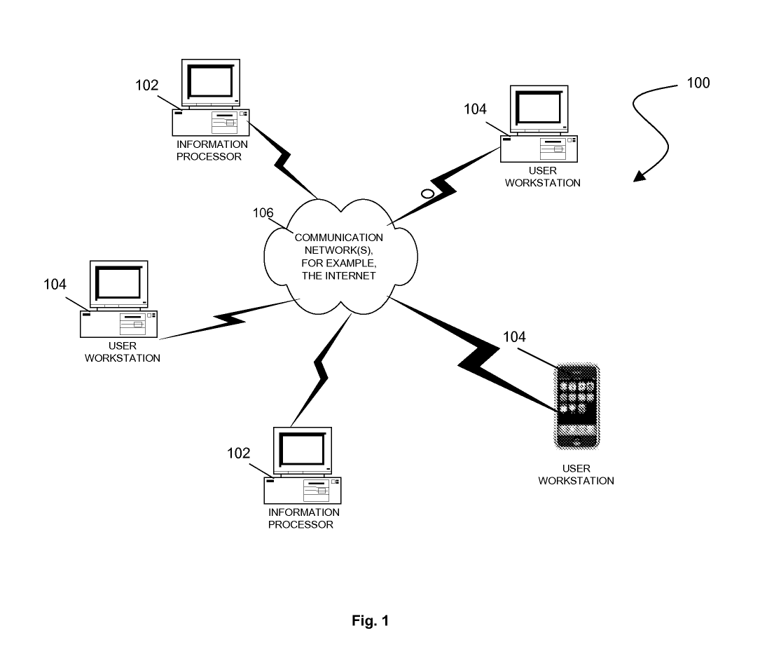

Referring now to the drawing figures, in which like reference numerals represent like elements, FIG. 1 illustrates an example hardware arrangement in accordance with an embodiment of the present application. Referred to generally, herein, as system 100, the arrangement provides for monitoring and notification services in accordance with the teachings herein. System 100 includes at least one information processor 102 (configured to operate as an Internet web server and/or database file server) that is programmed and configured to access communication network 106 and communicate with computing device(s) 104. Computing devices 104 may be personal computers, and may further be mobile devices, such as operating one or more of the GOGLE ANDROID, APPLE IOS, WINDOWS MOBILE operating systems, and may include smartphone devices, tablet computing devices, other mobile portable devices. Computing devices 104 and information processor(s) 102 may communicate via the known communications protocol, Transmission Control Protocol/Internet Protocol “TCP/IP.” Information processor 102 and computing device(s) 104 preferably are provided with or have access to all databases necessary to support the present application.

Communication network 106 is preferably a global public communication network such as the Internet, but can also be a wide area network (WAN), local area network (LAN), an intranet or other network that enables computing devices and peripheral devices to communicate.

In a preferred embodiment, information processor(s) 102 and computing devices 104 are preferably equipped with web browser software, such as MICROSOFT INTERNET EXPLORER, MOZILLA FIREFOX, APPLE SAFARI or the like. Information processor 102 and computing devices 104 are coupled to communication network 106 using any known data communication networking technology.

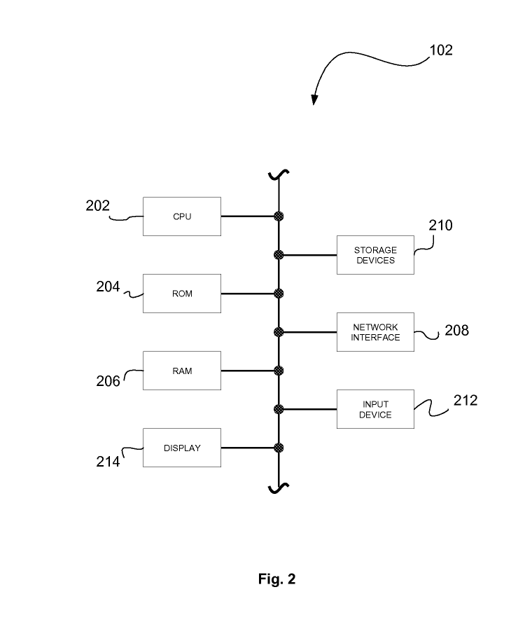

FIG. 2 illustrates functional elements, of which one or more may be configured in an example information processor 102 and/or computing device 104. The functional elements shown in FIG. 2 include one or more central processing units (CPU) 202 used to execute software code and control operations. Other elements shown in FIG. 2 include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components illustrated in FIG. 2 need not be physically contained within a single device chassis or even located in a single location. For example, storage device 210 may be located at a site that is remote from the remaining elements of information processor 102, and may even be connected to CPU 202 across communication network 106 via network interface 208. Information processor 102 and/or computing device 104 may include a memory equipped with sufficient storage, such as to provide or access the necessary databases, forums, and other community services communicating hypertext markup language (HTML), Java applets, Active-X control programs. Information processor 102 and/or computing device 104 are arranged with components, for example, those shown in FIG. 2, suitable for the expected operating environment. The CPU(s) 202, network interface(s) 208 and memory and storage devices are selected to ensure that capacities are arranged to accommodate expected demand.

The nature of the present application is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL and PHP.

Although the present application is described by way of example herein and in terms of a web-based system using web browsers and a web site server (e.g., information processor 102), system 100 is not limited to such a configuration. It is contemplated that system 100 is arranged such that information processor 102 and/or computing devices 104 communicate with and outputs data using any known communication method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 102 and/or computing device 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, WINDOWS 7, MAC OS, UNIX, LINUX, PALM OS, POCKET PC, BLACKBERRY, ANDROID, IOS and any other suitable operating system.

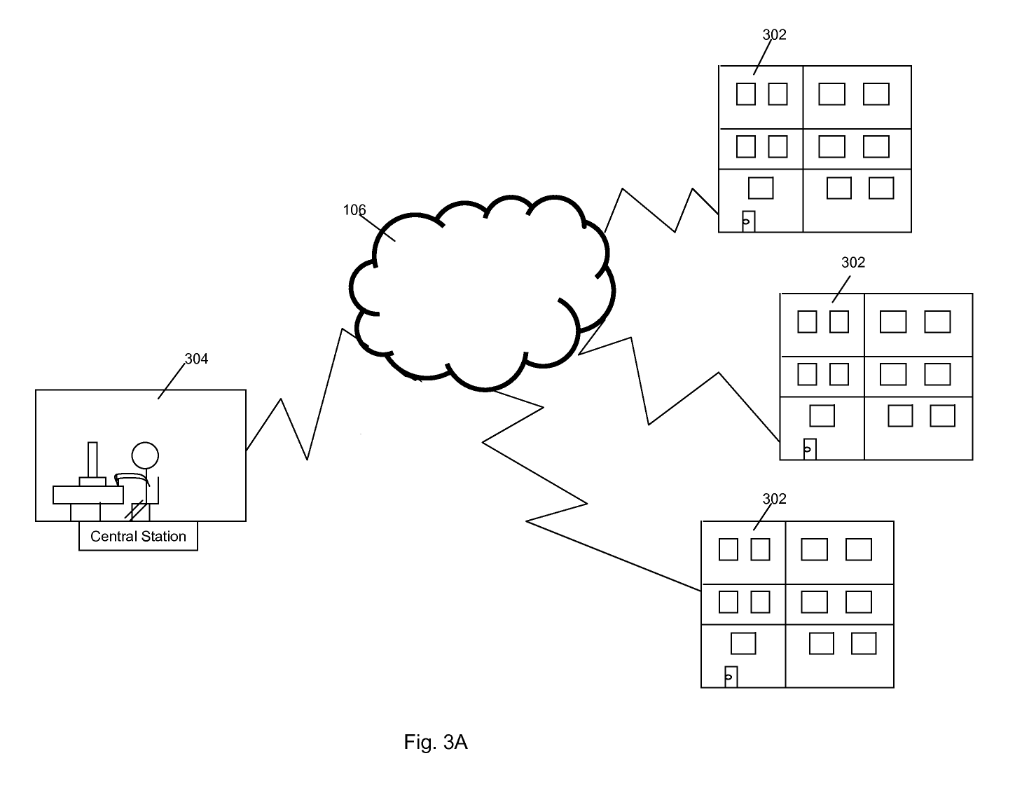

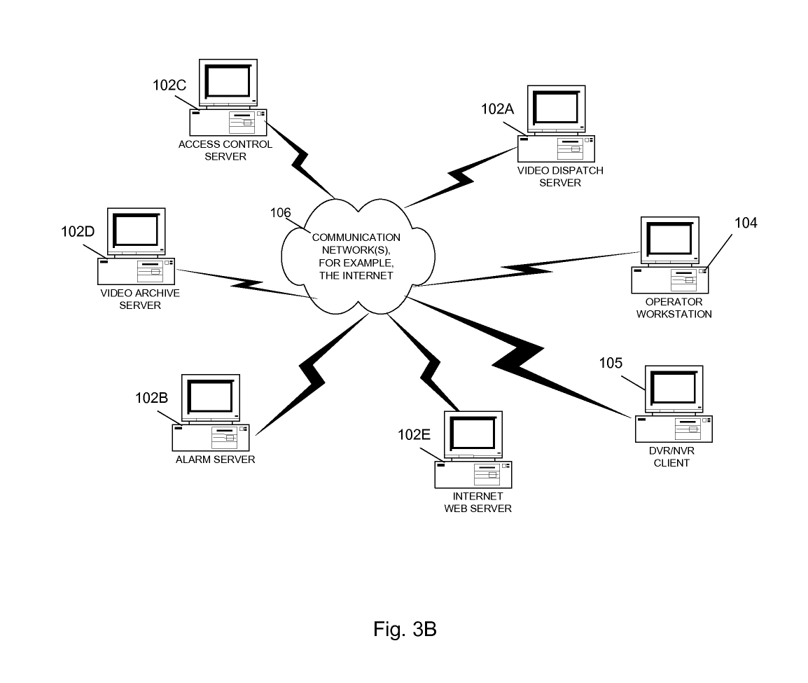

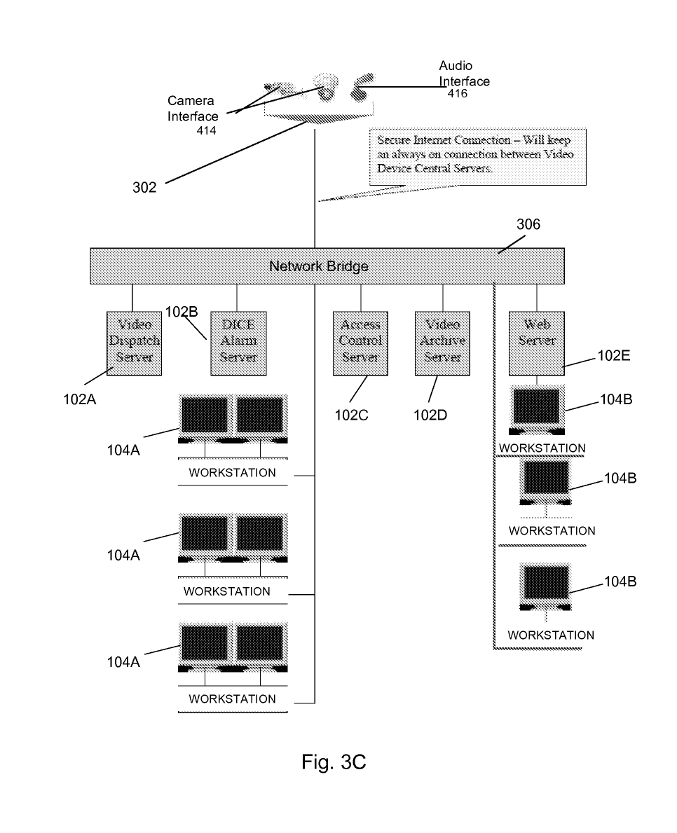

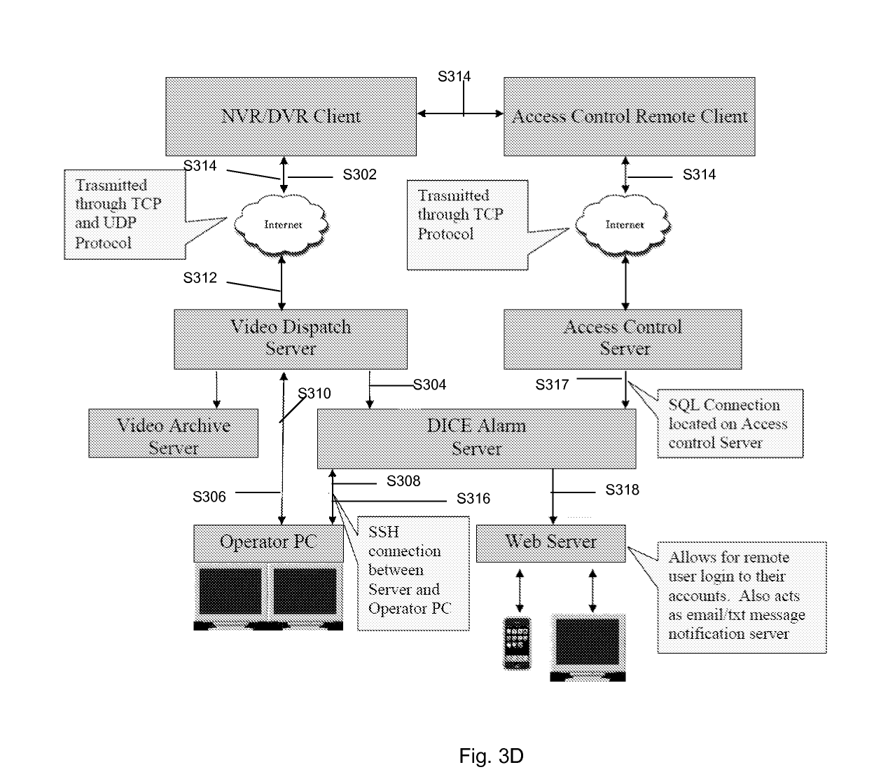

FIG. 3A illustrates an example arrangement in accordance with an embodiment of the present application. As shown in FIG. 3A, a plurality of buildings 302 are configured to communicate over communication network 106. As noted above, an active on-line connection, including for communication with central station 304, preferably is constantly maintained. Each of buildings 302 may be configured with one or more computing devices that are operable to send and receive information to and from central station 304 over communication network 106, and central station 304 is also configured to send and receive information associated with video and/or audio content, such as to and from respective buildings 302, and preferably manned by one or more monitoring personnel twenty-four hours a day, seven days a week.

FIG. 3B illustrates an example hardware arrangement in accordance with an embodiment and includes respective information processors 102, workstation(s) 104 and DVR/NVR client(s) 105 that are accessible by or provided with the central monitoring station. The respective information processors 102 that are illustrated in FIG. 1B are operable to send and receive information over communication network 106, including to and from workstations 104 and client device 105 that are located remotely and communicating over network 106.

For example, and with reference to FIG. 3B, an event (e.g., a forced entry event) occurs at a residential building 302, and video content associated therewith is received by video dispatch server 102A from a respective DVR client 105 that is located at the residential building. Video dispatch server 102A transmits a notification of the event to alarm server 102B and to operator workstation 104. The video content is provided to operator workstation 104 by video dispatch server 102A, and interactive functionality is provided between an operator of workstation 104 and the respective DVR client. Using the interactive functionality, a user of operator workstation 104 issues a command via access control server 102C for controlling access to one or more entranceways and windows of the residential building. Video content, including of the forced entry event and subsequent activity, is stored in video archive server 102D, for future review and access. Moreover, content relating to the event (including corresponding video content) is made available on communication network 106 via internet web serer 102E. Notifications, such as e-mail, message, voice or other format may be transmitted by web server 102E or other suitable server 102 (not shown).

Thus as described in connection with the above example and illustrated in FIG. 3B, respective devices are configured for one or more users to view live and/or recorded images and engage in interactive sessions with one or more client devices and persons.

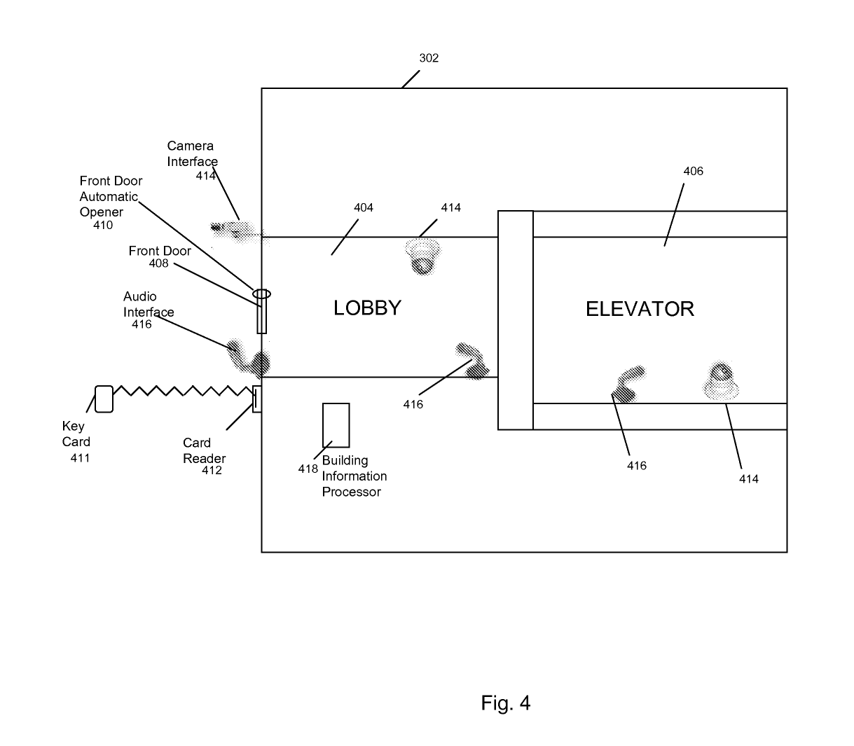

FIG. 3C illustrates an example hardware arrangement, particularly associated with central station 304 in accordance with an embodiment of the present application. Included in FIG. 3C are camera interfaces 414 and audio interface 416 (FIG. 4) that are provided with a respective building 302. Data, such as video and/or audio content are transmitted via network 106 and network bridge 306, which is preferably a suitable network switch, such as provided by LINKSYS, CISCO, NETGEAR 3COM or the like and operable to process and/or route data to, from and/or between respective devices, including servers 102A, 102B, 102C, 102D and 102E. Also illustrated in FIG. 3C are workstations 104A that are preferably provided with or operable with central station 304. Moreover, workstations 104B are configured, for example, with web browser software and operable to communicate with web server 102E over communication network 106.

FIG. 3D illustrates a flow chart including steps S300 associated with an embodiment and transmitting information to and from respective devices, including servers 102A, 102B, 102C, 102D and 102E, and client devices, including workstations 104A and 104B, shown and described herein. At step S302, DVR/NVR client 105 (FIG. 3B) sends electronic information via network 106 to video dispatch server 102A (FIG. 3B). The information may be transmitted, for example, using TCP/IP and/or UDP protocols. The information sent by DVR/NVR client 105 in the example shown in FIG. 3D represents the occurrence of a condition or an event, such as an attempted break-in, loitering, or a door is ajar. Thereafter, video dispatch server 102A transmits information representing the event to alarm server 102B (step S304). In an embodiment, a terminal connection between video dispatch server 102A and alarm server 102B is maintained in an active (on) status. Upon an event, dispatch server 102A sends alphanumerical text information to alarm server 102B. The text information may include, for example, the client ID and relative alarm or status information. The information transmitted by video dispatch server 102A may be the same information, for example, that is forwarded to alarm server 102B. Alternatively, the information transmitted by video dispatch server 102A may be different, but still associated with the particular electronic information received from DVR/NVR client 105. Moreover, the information transmitted by video dispatch server 102A may be newly generated information that is based on the information received from DVR/NVR client 105. In addition, information representing the event is transmitted from video dispatch server 102A to one or more operator workstations 104A (step S306). In an embodiment, operator workstation 104A is configured with software that enables workstation 104A to receive audio/video content, as well as to interact with one or more audio/video interface device(s) 414, 416 (FIG. 4), substantially in real time. Operators of workstation 104A are preferably able to view video content, determine the status of a particular condition as represented by information received from video dispatch server 102A. Operators may also interact with one or more persons remotely and who may be located at building 302.

Continuing with the example flow chart shown in FIG. 3D, an operator of workstation 104A receives information representing a signal/alarm while receiving video content of the respective event (step S308). Preferably, the information transmitted to workstation 104A is provided via a secured (e.g., SSH) communication session between alarm server 102B and workstation 104A. In an embodiment, the operator first receives the alarm event within the alarm automation software. Upon receiving the alarm and then acknowledging it on the screen, a command is sent from the terminal to the video client, which then connects and displays the associated video alarm on the screen. A command is preferably issued after the operator acknowledges the signal/alarm, which causes corresponding audio and/or video content that is provided in a video client software queue to be provided on the operator's workstation 104A. The Queue is stored in the dispatch server, however it may be available to see by all video clients. In a preferred embodiment, audio and/or video content from a plurality of buildings 302, including content associated with one or more respective events is queued for possible review. By queuing content representing a plurality of events and retrieving any of the content, an operator of workstation 104A is able to access video and audio content, and interact with the appropriate remote DVR/NVR client 105 in a particular context.

Information from the access control remote client, located at the client side, is sent over the internet via TCP protocol to Access Control Servers 102C (step S317). The information may include, but is not limited to, panel status (power, battery, tampers), system events (access grants, access denies), alarm events (door forced open, door left open). The information is then sent via SQL database to alarm servers 102B, which in turn relay information (if necessary) to an available operator. From there, depending on the event, the operator can initiate a video/audio connection to site in order to address the issue at hand.

Continuing with reference to FIG. 3D, using the audio/video content received from video dispatch server 102A and information provided by alarm server 102B, the operator of workstation 104A determines that a door should be released at a respective building 302. Accordingly, the operator issues a command, for example, via from the operator video client software operating on workstation 104A, to video dispatch server 102A (step S310). Video dispatch server 102A sends the command (or a command associated with the command received by workstation 102A) through network 106 and the command is received by NVR/DVR Client 105 (step S312). Thereafter, the command is issued to access control server 102C, which causes an output, such as to release a door (step S314). The command is from the sent from the operator station, through video dispatch server 192A, to the DVR/NVR client(s) 105. The DVR/NVR client(s) 105 then triggers the appropriate output relay which is connected to the access control client. After the video/audio interaction with the operator and the door is released, the operator chooses to send an email or other message format notification of the event (step S316). The message is sent via one or more software commands that are transmitted to alarm server 102B and, thereafter, to Internet web server 102E (S318). In an embodiment, the message is posted to server 102E and secured access to the message is made for users who provide authentication information. Further, remote user access is preferably made available for users who submit appropriate authentication information. This enables users to securely log in to their accounts, and view information therefor. Moreover, Internet web server 102E may be configured to operate as an e-mail and/or message notification server.

FIG. 4 illustrates an example building that is configured with hardware and software providing functionality disclosed herein, and for transmitting various information to and receive information from servers 102A, 102B, 102C, 102D and 102E. As shown in FIG. 4, building 302 includes lobby portion 404 and elevator portion 406. Building 302 further includes front door 408 for residents and visitors to enter and exit building 302. Front door 404 is preferably locked at all times, and can be unlocked via front door automatic opener 410. Front door automatic opener 410 functions to unlock front door 408 in response to a command issued from card reader 412 or remotely from one or more other locations, such as central station 304. As a resident wishes to enter building 302, the resident places key card 411 in or near card reader 412, and an identifier therein authorizes front door automatic opener 410 to unlock front door 408 so that the resident may enter building 302. Key card 411 is preferably a programmable smart card that includes a radio frequency identification (“RFID”) or other communication element to enable card reader 412 to recognize and read the content stored thereon. In the event, for example, a resident loses his or her key card 411, a new key card 411 may be programmed, preferably with a different identifier to ensure that the lost key card 411, if found by someone else, does not allow for unauthorized access to building 302.

Continuing with the example shown in FIG. 4, camera interface 414 and audio interface 416 provide audio/visual communications between one or more people located inside and/or outside of building 302, including one or more parties located in central station 304. In the example shown in FIG. 4, camera interface 414 and audio interface 416 are illustrated separately. One skilled in the art will recognize that integrated systems are available wherein camera interface 414 and audio interface 416 are packaged or provided in a single installable unit, and that any such suitable configuration is supported by the present application. Further, camera interface 414 may include a display screen to provide 2-way video communication. This enables someone at central station 304, for example, to be seen by someone located outside or inside of building 302. Audio interface 416 preferably includes one or more of a microphone and loud speaker that are configured to receive audio signals from and send audio signals to one or more people located in close proximity to audio interface 416. Using video interface 414 and audio interface 416, one or more persons located in close proximity to interfaces 414, 416 can maintain live, interactive communications with, for example, personnel located at central station 304. Also as shown in FIG. 4, camera interface 414 and audio interface 416 are provided in various locations within building 302, such as in lobby area 404 and elevator area 406. By configuring different parts of building 302 with camera interface 414 and audio interface 416, a single person who enters building 302 can be monitored and kept in constant communication and surveillance while the person moves from area to area within building 302.

Also as shown in FIG. 4, building information processor 418 is provided which may be a computing device operable to interface with various components and devices shown in FIG. 4 and located in building 302. For example, when a person places key card 411 in front of card reader 412, a signal is transmitted to building information processor 418 that someone who is authorized to enter building 302 is requesting that front door 408 unlock. Building information processor 418 may subsequently send a signal to front door automatic opener 410 to unlock front door 408. Of course, one skilled in the art will recognize that other configurations of a wireless key entry are envisioned herein, such as key card reader 412 and front door automatic opener 410 integrated as a single unit without being controlled by building information processor 418. In an embodiment, whenever someone places key card 411 in reading proximity of card reader 412, a signal that includes the identifier programmed in key card 411, a date and time stamp, and any other suitable information, such as the name of the person to whom key card 411 was issued, the person's apartment number, or the like is sent to building information processor 418.

As noted above and in a preferred embodiment, functionality is provided via building information processor 418 to send notifications or alerts to designated people when one or more persons enters or exits building 302. For example, a child comes home from school at 3:15 pm on a weekday while both parents are still away at work. The child uses his key card 411 to enter building 302. A signal is transmitted to building information processor 418 and used to identify that the child is entering the building. Further, transmissions from camera interface 414 are received by building information processor 418 and stored. As the child enters the building, camera interface 414 located in lobby area 404 sends image transmission(s) to building information processor 418. As the child enters elevator 406, camera interface 414 in elevator 406 sends image transmission(s) to building information processor 418. Thereafter, building information processor 418 collects the information received in connection with the entering of the child into building 302, and sends an e-mail or other notification to the parent(s) of the child. Further, access to the image transmission(s) received by building information processor 418 from the respective camera interfaces 414 may be included with the e-mail so that when the e-mail or other notification is received by the parent(s), the image transmission(s) can be viewed and the parent(s) can be assured the child's safety. One skilled in the art will recognize that image transmission(s) often require a substantial amount of network bandwidth and in one or more alternative embodiments, the image transmission(s) may be provided in different ways. For example, the image transmission(s) may be stored and available via a secured Internet website and a hyperlink to the image transmission(s) may be included in the message or notification that is sent to the parent(s). In this way, when the message is received from building information processor 418 (or other suitable device), the hyperlink is selected and the image transmission(s) of the child entering the building and safely getting on the elevator and any other transmission(s) that may be captured, such as when the child enters the apartment, are viewable over a secured Internet access.

In a preferred embodiment, every transmission that is sent to and received by building information processor 418 from any respective component or feature of building 302 that is configured to transmit information to building information processor 418 is stored and archived. In one embodiment, at least some transmission(s) received by building information processor 418 are transmitted to central station information processor 102. One skilled in the art will recognize that many configurations for storing large volumes of data are possible and are supported by the teaching herein. For example, data may be periodically streamed to central station information processor 102 and transferred to one or more storage devices, such as DVR devices. Moreover, data, including all audio/video transmissions, may be stored in one or more data storage devices located in building 302.

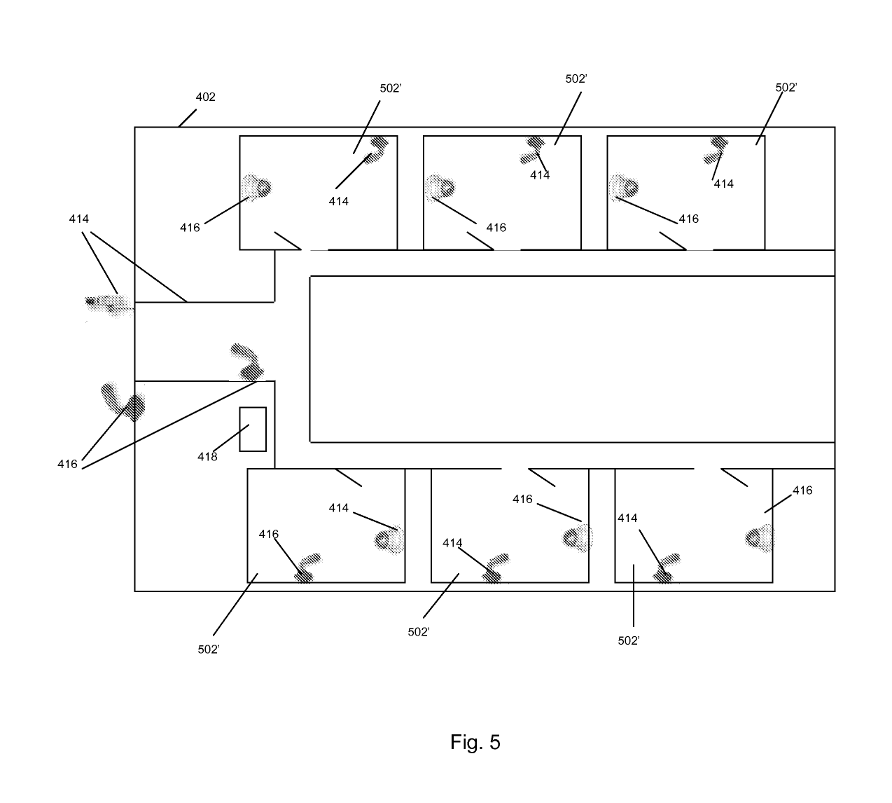

FIG. 5 illustrates interior space of an example building 302. As shown in FIG. 5, a plurality of rooms 502′ are each configured with camera interface 414 and audio interface 416. In the example shown in FIG. 5, each room 502′ is configured with interfaces 414, 416. Of course, one skilled in the art will recognize that any one or more rooms may not include any surveillance equipment.

As a person shows or receives authorization to enter building 302, an interactive audio-visual communication session may be initiated and maintained with personnel, for example, located in central station 304. As the person enters and walks through building 302, access to any respective room 502′ can be provided, for example, by an automatic door opener, such as automatic door opener 410 shown and described above with reference to FIG. 4. In this way, as a person moves throughout building 302, the person can be monitored and recorded during live, interactive communications with authorized personnel, such as in central station 304. The person in the building can further be monitored in the rooms in the event that any action taken by the person, such as an attempt to take an item or replace an item without permission in a respective room, occurs. In an example, an inquiry can immediately be made and the person directed to either replace or remove the item. In the event of an emergency situation, such as theft, vandalism or other behavior, central station 304 can immediately contact emergency personnel for dispatch to the scene. This provides building owners and residents alike with security and assurance that access to buildings and rooms will not result in harm.

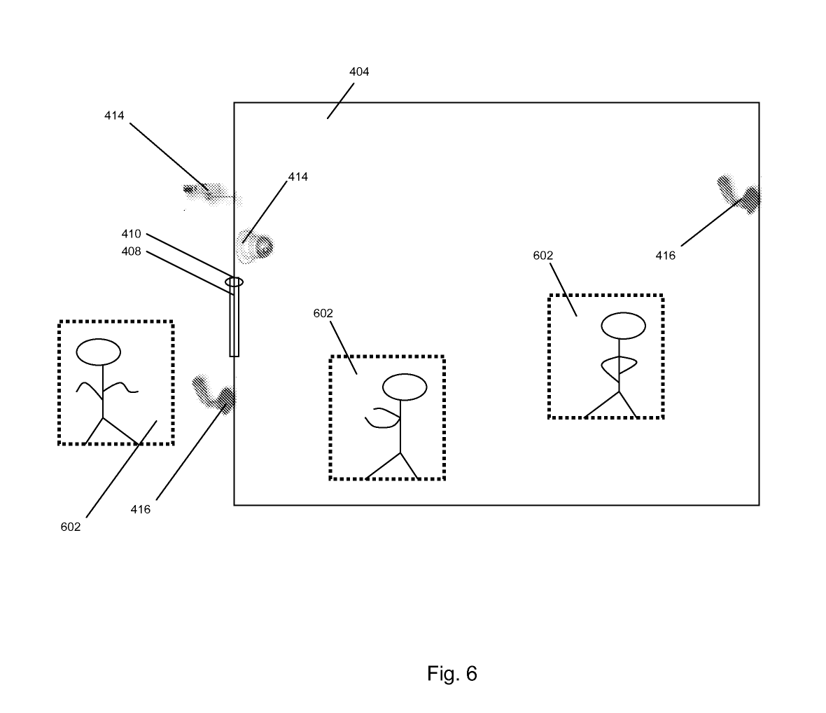

FIG. 6 illustrates an example lobby area 404 in building 302 and represents anti-loitering functionality provided in accordance with the present application. In the example embodiment shown in FIG. 6, camera interface 414 captures images of lobby area 404, and in close proximity outside of building 302. Images are sent to an information processor 102, such as building information processor 418, and loitering analytics are performed to determine whether anyone is loitering around or in building 302. In the example shown in FIG. 6, three individuals are monitored with loitering analytics portion 602 surrounding each person. In an embodiment, loitering analytics portion 602 is used by building information processor 418 to determine a length of time in which one or more persons remain at a particular place or within a range of movement. For example, when a person stops moving at a particular space, a timing mechanism is implemented by building information processor 418 and used to determine a length of time that the person stays within a particular position. Building information processor 418 can further determine how far the person moves from the initial position, which enables a determination that the person is loitering. In the event that building information processor 418 (or other remotely connected information processor 102) determines that someone is loitering, communication can be established, such as via audio interface 416, and the person(s) can be instructed to leave the premises at once. In the event that the loitering does not end, proper authorities including emergency personnel can be alerted and dispatched, for example, via central station 304. Thus, in accordance with the present application, building owners, managers and residents are assured that their buildings are free from loiterers.

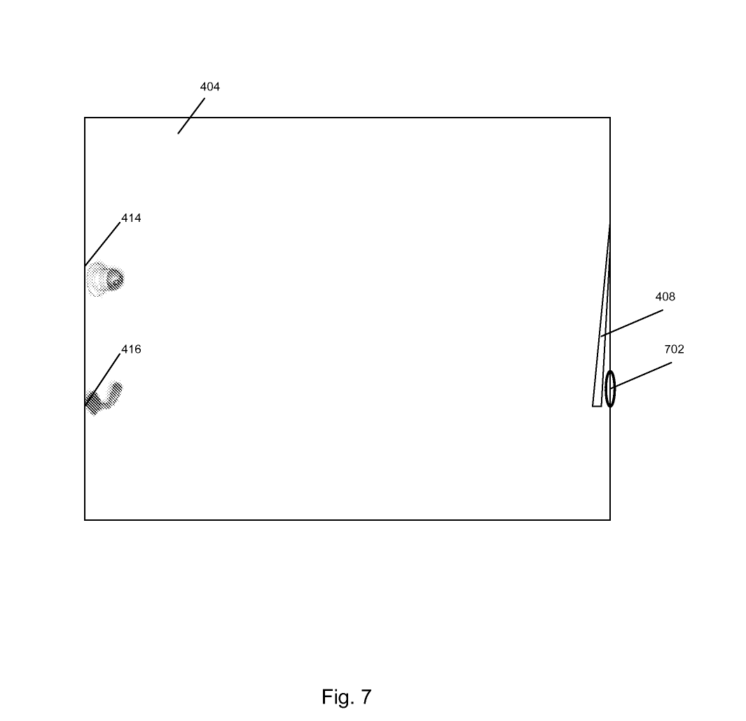

FIG. 7 illustrates functionality associated with ensuring that doors in a building are securely closed. FIG. 7 illustrates an example lobby area 404 within building 302 and includes front door 408 and door ajar monitoring device 702. In the example shown in FIG. 7, front door 408 is not fully closed. For example, someone left building 302 and the latch on front door 408 did not sufficiently connect to securely close the door. When a door is detected to be not closed securely, such as via monitoring device 702, information is relayed via an information processor 102, such as building information processor 418, to generate an alert or message to authorized personnel. For example, a text message or telephone voice message is sent to a building manager of building 302. Once the message is received, the manager can go to the respective door, such as front door 408, secure the door and repair any problem with the door that initially caused the door from closing properly. In addition to monitoring device 702 being applied to doors, other entranceways in building 302 are applicable for device 702. For example, windows, crawlspaces or virtually any other building access point may be configured with monitoring device 702, which may be suitably configured therefore and prevent unauthorized access to building 302.

Thus, and as illustrated and described above with reference to FIG. 7, the present application provides assurances for building owners, managers and residents that their building entrances and exits are secure.

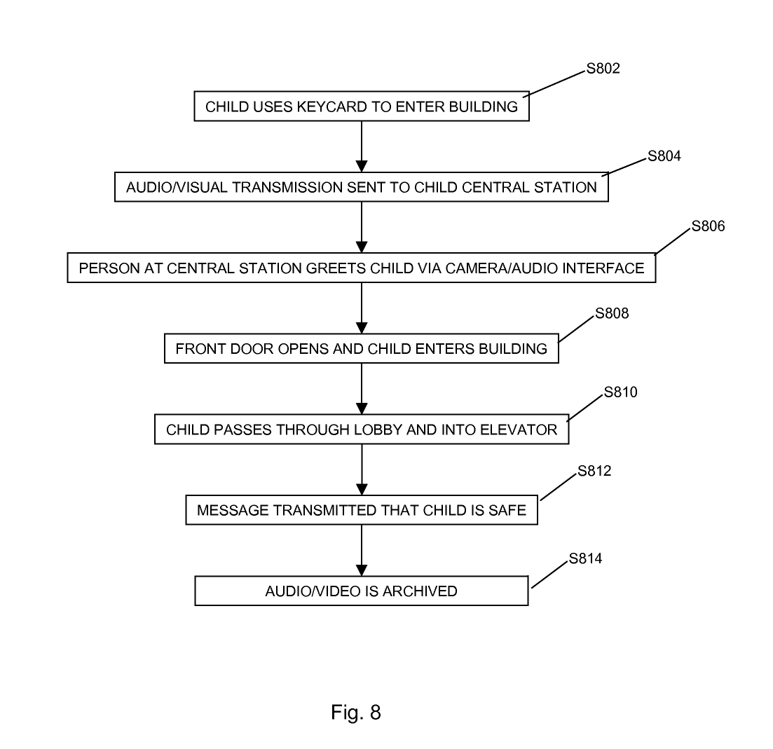

FIG. 8 is a flowchart that illustrates example steps associated with a child arriving at home and parents being notified that the child is safe. At step S802, the child uses his key card to enter building 302. Thereafter, an audio-visual transmission is sent to central station 304 (step S804). The person at central station 304 greets the child via one or more of camera/audio interfaces 416, 418 (step S806). Front door 408 opens via front door automatic opener 410, and the child enters the building (step S808). As the child passes through lobby 404, and enters elevator 406, the child's actions are monitored and communication may be maintained via camera interface 414 and audio interface 416 with the child (step S810). After the child enters his apartment, a message is transmitted to a parent of the child that the child has arrived safely from school and is in his apartment (step S812). All audio and video content is stored and archived in one or more storage devices (step S814). Thus, and as shown and described with reference to FIG. 8, options are provided in accordance with the teachings herein for parents or others to be notified when their children arrive home safely from school. This eliminates a common concern among parents, particularly those who work and whose children arrive home without a parent or other individual present. Parents are provided with audio-visual content proving that their children are safe for increased peace of mind.

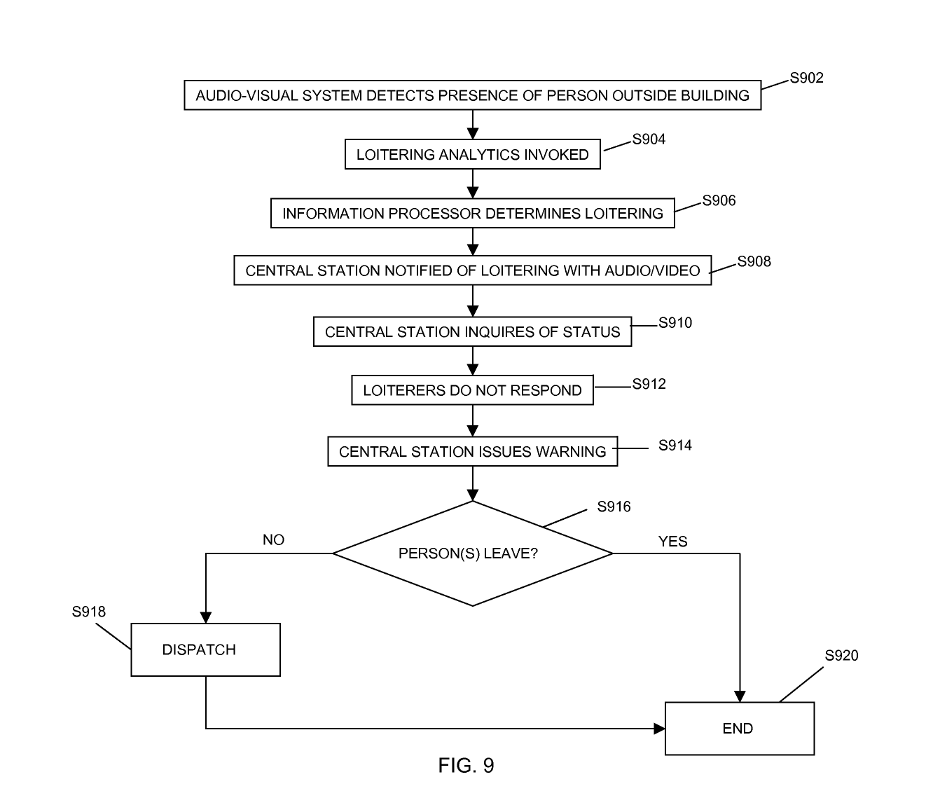

FIG. 9 is another flowchart illustrating example steps associated with anti-loitering measures provided in accordance with the present application. At step S902, a person outside of building 302 is detected via camera interface 414 and/or audio interface 416. Thereafter, loitering analytics are invoked by building information processor 418, such as shown and described above in connection with FIG. 6 (step S904). In response, building information processor 418 transmits a notification of possible loitering to central station 304 (step S906). Personnel at central station 304 are alerted of the possible loitering, and contact the one or more persons via camera interface 414 and/or audio interface 416 and inquire as to the status (step S908). The person(s) who is contacted by central station 304 does not respond to the status inquiry (step S910). In response, central station 304 issues a warning to the person(s) that their presence is not permitted and that they have to depart the premises immediately. At step S914, a determination is made whether the person(s) has left. If not, then the process branches to step S916, and authorized personnel, such as police or other emergency personnel are contacted by central station 304 and requested for dispatch on the scene. Alternatively, if the person(s) respond to central station's 304 warning from step S912, then the process ends at step 918. In either case, and as shown and described with reference to FIG. 9, the present application provides mechanisms to prevent loitering and to handle loiterers, for example, by dispatching police.

As noted above, in a preferred embodiment, building information processor 418 is programmed and configured to determine if any device, such as camera interface 414, audio interface 416, front door automatic opener 418, card reader 412, door ajar notification monitor 702 or any other respective device associated or in accordance with the teachings herein is not functioning properly or in need of maintenance. In addition to monitoring periodic “heartbeats,” testing is conducted periodically in an automatic fashion to confirm that the respective components of the system are fully operational and responsive. In the event that any one or more devices is not operating properly, or is in need of maintenance, a message is generated and transmitted to an appropriate person, such as personnel at central station 304, a building manager or other person who is predefined to be notified in such event.

Thus, in accordance with the teachings herein, a security system and method are provided that includes a complex and integrated arrangement of equipment for surveillance, communications, monitoring control of locks for doors, windows and/or other entranceways. Electronic information is received and managed by one or more processing devices, and stored and archived in one or more storage devices. Anti-loitering, door ajar notification, latch key child notification and other notifications are provided as a function of audio/video surveillance and twenty-four communications with a central station. Access to secured buildings are restricted to tenants and/or their guests, and forced entry to buildings including via doors and entranceways is detected and/or prevented. By providing card access door control management, round the clock video recording, escorting, anti-loitering, door ajar, forced entry dispatch and maintenance monitoring, building owners, residents, managers and other interested parties are assured of secure, safe and well-maintained building environments.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A method, comprising:
a) storing on one or more processor readable media that are operatively coupled to one or more processors, at least one database that includes:
i) electronic surveillance information comprising one or more of video content and audio content respectively obtain from video surveillance equipment located at a plurality of multi-dwelling units;
ii) electronic meta-data associated with the electronic video content and the electronic audio content; and
iii) user information associated with a plurality of registered users;
b) receiving, from a first DVR/NVR computing device over a communication network first electronic surveillance information comprising:
i) one or more of video content and audio content respectively associated with a first of the plurality of multi-dwelling units; and
ii) first electronic meta-data representing information associated with the first electronic surveillance information;
c) determining, by the one or more processors and based at least on some of the first electronic surveillance information, at least one event;
d) transmitting, by the one or more processors to a first user computing device, electronic event information associated with the event and at least some of the first electronic surveillance information;
e) receiving, from the first user computing device in response to the event information, at least a first electronic command representing an action to be taken at the first multi-dwelling unit;
f) transmitting, by the one or more processors, the first electronic command to an access control computing device;
g) receiving, from the computing device electronic message information representing a message for at least one of the plurality of users; and
h) transmitting, by the one or more processors, the electronic message information to a message computing device.

2. The method of claim 1, further comprising establishing, by the one or more processors, a communication session between first user computing device and the first DVR/NVR computing device.

3. The method of claim 1, wherein the event is one or more of a door ajar condition, a forced entry, a delivery, and a loitering condition.

4. The method of claim 1, wherein the electronic command, when executed by the access control computing device, functions to control one or more hardware devices provided at the first multi-dwelling unit.

5. The method of claim 1, wherein at least some of the electronic event information includes streaming video.

6. The method of claim 1, wherein the electronic message is transmitted by the one or more processors as e-mail.

7. A system, comprising:
one or more processor readable media that are operatively coupled to one or more processors;
at least one database stored on the one or more processor readable media, wherein the at least one database includes:
i) electronic surveillance information comprising one or more of video content and audio content respectively obtain from video surveillance equipment located at a plurality of multi-dwelling units;
ii) electronic meta-data associated with the electronic video content and the electronic audio content; and
iii) user information associated with a plurality of registered users; and
electronic instructions stored on the one or more processor readable media that, when executed, cause the one or more processors to:
receive, from a first DVR/NVR computing device over a communication network first electronic surveillance information comprising:
i) one or more of video content and audio content respectively associated with a first of the plurality of multi-dwelling units; and
ii) first electronic meta-data representing information associated with the first electronic surveillance information;
determine, based at least on some of the first electronic surveillance information, at least one event;
transmit, to a first user computing device, electronic event information associated with the event and at least some of the first electronic surveillance information;
receive, from the first user computing device in response to the event information, at least a first electronic command representing an action to be taken at the first multi-dwelling unit;
transmit the first electronic command to an access control computing device;
receive, from the computing device, electronic message information representing a message for at least one of the plurality of users; and
transmit the electronic message information to a message computing device.

8. The system of claim 7, wherein the electronic instructions, when executed, further cause the one or more processors to establish a communication session between first user computing device and the first DVR/NVR computing device.

9. The system of claim 7, wherein the event is one or more of a door ajar condition, a forced entry, a delivery, and a loitering condition.

10. The system of claim 7, wherein the electronic command, when executed by the access control computing device, functions to control one or more hardware devices provided at the first multi-dwelling unit.

11. The system of claim 7, wherein at least some of the electronic event information includes streaming video.

12. The system of claim 7, wherein the electronic message is transmitted as e-mail.
